(19) United States
(12) Patent Application Publication
(10) Pub. No.: US 2019/0057477 A1
(43) Pub. Date: Feb. 21, 2019

(54) METHOD AND SYSTEM FOR PROVIDING TRANSPORTATION SERVICE

(71) Applicant: BEIJING DIDI INFINITY TECHNOLOGY AND DEVELOPMENT CO., LTD., Beijing (CN)

(72) Inventors: Xiang LI, Beijing (CN); Zhiqiang ZHOU, Beijing (CN); Zhan WANG, Beijing (CN); Kehua SHENG, Beijing (CN)

(73) Assignee: BEIJING DIDI INFINITY TECHNOLOGY AND DEVELOPMENT CO., LTD., Beijing (CN)

(21) Appl. No.: 15/855,746

(22) Filed: Dec. 27, 2017

(30) Foreign Application Priority Data
Aug. 16, 2017 (CN) 201710702596.3

(51) Int. Cl. G06Q 50/30; G06Q 10/06

(52) U.S. Cl. CPC G06Q 50/30; G06Q 10/06316

(57) ABSTRACT

Methods and systems for providing transportation service are provided. The method can include detecting, by at least one processor, a request queue associated with an area. The method can further include receiving transportation service requests, from remote terminal devices, to be placed in the request queue. The method can also include determining, by the at least one processor, a number of the transportation service requests for the request queue. The method can further include activating, by the at least one processor, the request queue in response to the determined number being greater than an activation threshold; and providing transportation service according to respective positions of the transportation service requests in the activated request queue.

### CROSS REFERENCE TO RELATED APPLICATION

The present application is based on and claims the benefits of priority to Chinese Application No. 201710702596.3, filed Aug. 16, 2017, the entire contents of which are incorporated herein by reference.

### TECHNICAL FIELD

The present disclosure relates to providing transportation service, and more particularly to, methods and systems for queuing a transportation service request.

### BACKGROUND

An online hailing platform (e.g., DiDi™ online) can receive a transportation service request from a passenger and then dispatch a service vehicle (e.g., a taxi, a private car, or the like) to fulfill the service request. Generally, requests are processed on a first-in-first-out basis in the order the requests are received. However, exceptions may be made to urgent requests related to medical necessity or compelling business reasons. When the number of requests exceeds the capacity of service vehicles, a queue may form to process the requests according to a predetermined order. In this queue, some priority requests can be processed out of order, while the remaining non-priority requests are generally processed on a first-come-first-serve basis. Thus, non-priority requests in this area may have to wait for an undesirable period of time as the limited resources are being used to satisfy the priority requests first, if the queue is activated when a priority request is made.

Therefore, to provide a balance between the non-priority requests and the priority requests, the queue should be activated only when it is necessary. Embodiments of the disclosure address the problem of when to activate a queue by methods and systems for providing transportation service.

### SUMMARY

One embodiment of the disclosure provides a method for providing transportation service. The method can include detecting, by at least one processor, a request queue associated with an area. The method can further include receiving transportation service requests, from remote terminal devices, to be placed in the request queue. The method can also include determining, by the at least one processor, a number of the transportation service requests for the request queue. The method can further include activating, by the at least one processor, the request queue in response to the determined number being greater than an activation threshold; and providing transportation service according to respective positions of the transportation service requests in the activated request queue.

Another embodiment of the disclosure provides a system for providing transportation service. The system can include at least one processor configured to detect a request queue associated with an area. The system can further include a memory; and a communication interface configured to receive transportation service requests, from remote terminal devices, to be placed in the request queue. The at least one processor can be further configured to determine a number of the transportation service requests for the request queue. The at least one processor can be also configured to activate the request queue in response to the determined number being greater than an activation threshold, and provide transportation service according to respective positions of the transportation service requests in the activated request queue.

Yet another embodiment of the disclosure provides a non-transitory computer-readable medium that stores a set of instructions. When the set of instructions are executed by at least one processor of an electronic device, the set of instructions cause the electronic device to perform a method for providing transportation service. The method can include detecting, by at least one processor, a request queue associated with an area. The method can further include receiving transportation service requests, from remote terminal devices, to be placed in the request queue. The method can also include determining a number of the transportation service requests for the request queue. The method can further include activating the request queue in response to the determined number being greater than an activation threshold, and providing transportation service according to respective positions of the transportation service requests in the activated request queue.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of a system for providing transportation service, according to embodiments of the disclosure.

FIG. 2 illustrates a schematic diagram of an exemplary area, according to embodiments of the disclosure.

FIG. 3 illustrates a schematic diagram showing raising an activation threshold of a request queue, according to embodiments of the disclosure.

FIG. 4 illustrates a flowchart of an exemplary method for providing transportation service, according to embodiments of the disclosure.

FIG. 5 illustrates a flowchart of an exemplary method for determining a number of transportation service requests corresponding to a request queue, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

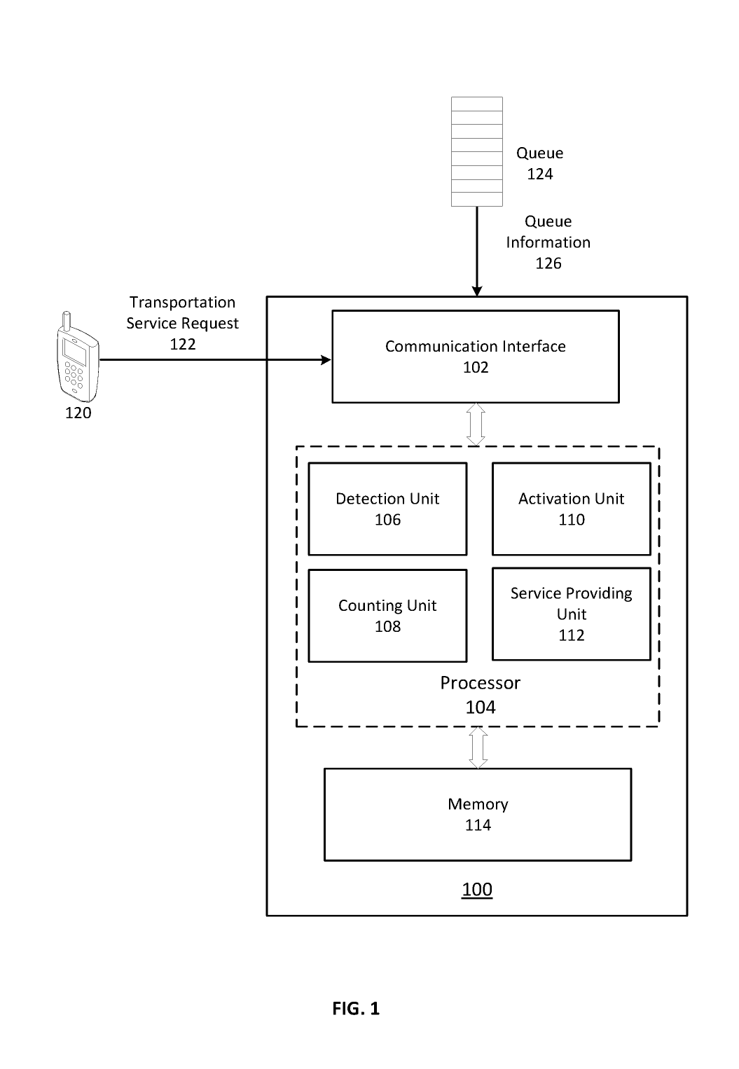

An aspect of the disclosure is directed to a system for providing transportation service. FIG. 1 illustrates a schematic diagram of a system 100 for providing transportation service, according to embodiments of the disclosure.

System 100 can be a general-purpose server or a proprietary device specially designed for providing transportation service. It is contemplated that, system 100 can be a separate system (e.g., a server) or an integrated component of a server. Because processing transportation service requests may require significant computation resources, in some embodiments, system 100 may be preferably implemented as a separate system. In some embodiments, system 100 may include sub-systems, some of which may be remote.

In some embodiments, as shown in FIG. 1, system 100 may include a communication interface 102, a processor 104, and a memory 114. Processor 104 may further include multiple modules, such as a detection unit 106, a counting unit 108, an activation unit 110, a service providing unit 112, and the like. These modules (and any corresponding sub-modules or sub-units) can be hardware units (e.g., portions of an integrated circuit) of processor 104 designed for use with other components or to execute a part of a program. The program may be stored on a computer-readable medium, and when executed by processor 104, it may perform one or more methods. Although FIG. 1 shows units 106-112 all within one processor 104, it is contemplated that these units may be distributed among multiple processors located near or remotely with each other. In some embodiments, system 100 may be implemented in the cloud, or on a separate computer/server.

Detection unit 106 may be configured to detect a request queue 124 associated with an area. For example, request queue 124 may contain priority service requests in a designated area. In some embodiments, request queue 124 can be a “non-strict” queue. Service requests in a “non-strict” request queue are not processed on a first-come-first-serve basis but based on priorities of the respective requests. In some embodiments, a priority of a request can be determined based on a collection of information associated with the requested transportation service, including, e.g., a request time, an origin, a destination, a length, an extra fee, a vehicle model, a type, an estimated price for the request or the like. In some embodiments, a full capacity may be set for request queue 124, e.g., 50 requests. Accordingly, when request queue 124 reaches its full capacity, request queue 124 cannot receive any further requests in the area. In this case, system 100 can provide another request queue to the area for providing service to priority passengers. In some embodiments, a request queue can be transferred to the area from another area nearby. For example, in New York City, request queue 124 is assigned to the Manhattan area and reaches its full capacity during rush hour while a queue in the Brooklyn area still has remaining capacity. System 100 can assign the Brooklyn queue to the Manhattan area to provide more priority service to the Manhattan area. System 100 may assign a fixed number of queues to a district (e.g., New York City), and a maximum number of queues to an area of the district (e.g., Manhattan area). The maximum number is less than or equal to the fixed number. The fixed number of queues assigned in a district can be set according to the computation capacity of the online hailing platform. It is contemplated that, when request queue 124 is detected, the detected queue may still have capacity for requests. That is, the detected queue may be partially filled with requests. However, it is possible that when the partially filled queue is detected, the area may have a fully filled queue already. Therefore, the detected queue may be not the only queue in the area.

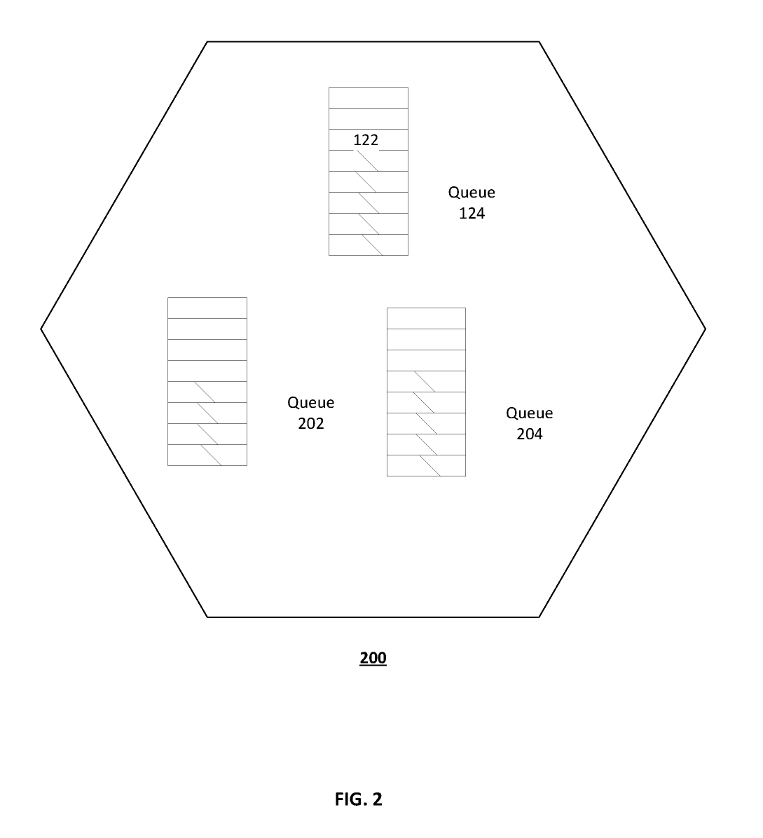

The area can be predetermined by system 100. For example, the area can be a hexagonal area that is neighbored with other hexagonal areas. It is contemplated that, the area can be of a shape other than a hexagon, such as a circle, a square, a rectangle, etc. In some embodiments, the shape and size of the area can be dynamically determined based on the current location of remote terminal device 120. FIG. 2 illustrates a schematic diagram of an exemplary area 200, according to embodiments of the disclosure. As shown in FIG. 2, area 200 is a hexagonal area, and includes queue 124, queue 202, and queue 204. Among these queues of area 200, queue 124 is inactive, queue 202 is active, and queue 204 is active. Consistent with the disclosure, an “inactive” queue cannot accept any further priority requests, and an “active” queue can add priority requests to its queue.

The queues (e.g., 124, 202, and 204) might be provided to different types of requests, e.g., a non-car-pooling queue and a car-pooling queue, or a queue for regularly-priced services and another queue for services with extra fees. Because the queuing mechanisms may be different, in some embodiments, the queues may have different capacities.

With reference back to FIG. 1, communication interface 102 may be configured to receive transportation service requests 122, from remote terminal devices 120, to be placed in request queue 124. Remote terminal devices 120 can be any suitable device that can interact with a user, e.g., a smart phone, a tablet, a wearable device, a computer, or the like. Remote terminal devices 120 may be mobile devices that can be carried by the passengers. Transportation service request 122 can include a current location of the passenger, an origin and a destination of the requested transportation, a request time, or the like. Generally, the origin of the requested transportation can be substantially close to a location of the remote terminal device. For example, remote terminal devices 120 may detect their respective locations and automatically assign the locations as the origins for the requests. However, it is contemplated that, the origin of the requested transportation service can differ from the location of the remote terminal device. For example, a user can request a transportation service from a computer for his/her friend, who is distant from this user. As another example, the user may reserve a transportation service to originate from a location he is moving towards.

Transportation service request 122 can be associated with a plurality of features (or otherwise known as “request parameters”), such as a price feature, a type feature, an area feature, and the like. These features characterize the requested transportation service. In some embodiments, the price feature can be generated based on transportation service request 122, and indicate a price that the passenger needs to pay for the transportation service. The area feature can indicate an area within which the transportation service request will be broadcasted, or stated in another way, the area from which service vehicles will be dispatched to fulfil the transportation service request. The type feature can be included in transportation service request 122, and indicate a type of the transportation service, including a non-car-pooling type, a car-pooling type, and the like.

In some embodiments, communication interface 102 can be an integrated services digital network (ISDN) card, cable modem, satellite modem, or a modem to provide a data communication connection. As another example, communication interface 102 can be a local area network (LAN) card to provide a data communication connection to a compatible LAN. Wireless links can also be implemented by communication interface 102. In such an implementation, communication interface 102 can send and receive electrical, electromagnetic or optical signals that carry digital data streams representing various types of information via a network. The network can typically include a cellular communication network, a Wireless Local Area Network (WLAN), a Wide Area Network (WAN), or the like.

Counting unit 108 can be configured to determine a number of transportation service requests 122 for request queue 124. It is contemplated that, when request queue 124 is detected, request queue 124 can be inactive. Therefore, counting unit 108 can assign transportation service requests 122 to request queue 124, but cannot queue transportation service requests 122 in request queue 124 yet. Counting unit 108 can identify transportation service requests 122 that belong to request queue 124, and determine a number of these identified transportation service requests 122.

Activation unit 110 can be configured to activate request queue 124 in response to the determined number being greater than an activation threshold. When the determined number is greater than the activation threshold (e.g., five requests), it indicates that the demand for transportation service exceeds the capacity of service vehicles by a certain number, and a queue becomes necessary. In some embodiments, at least one queue may already be active in an area, and the activation threshold for activating additional queues can be determined based on the number of one of the existing active queues. To avoid having too many queues for a particular area in the same district, activation unit 110 can be configured to increase the activation threshold in response as the number of existing active queues increases. In some embodiments, the activation threshold may be increased when the number of existing active queues exceed an activation number, for example, 1. That is, when an area contains more than one active queue, the activation threshold can be increased. For example, as discussed with reference to FIG. 2, there are two active queues 202 and 204 in area 200. Thus, the activation threshold of request queue 124 can be increased, making it harder to activate queue 124.

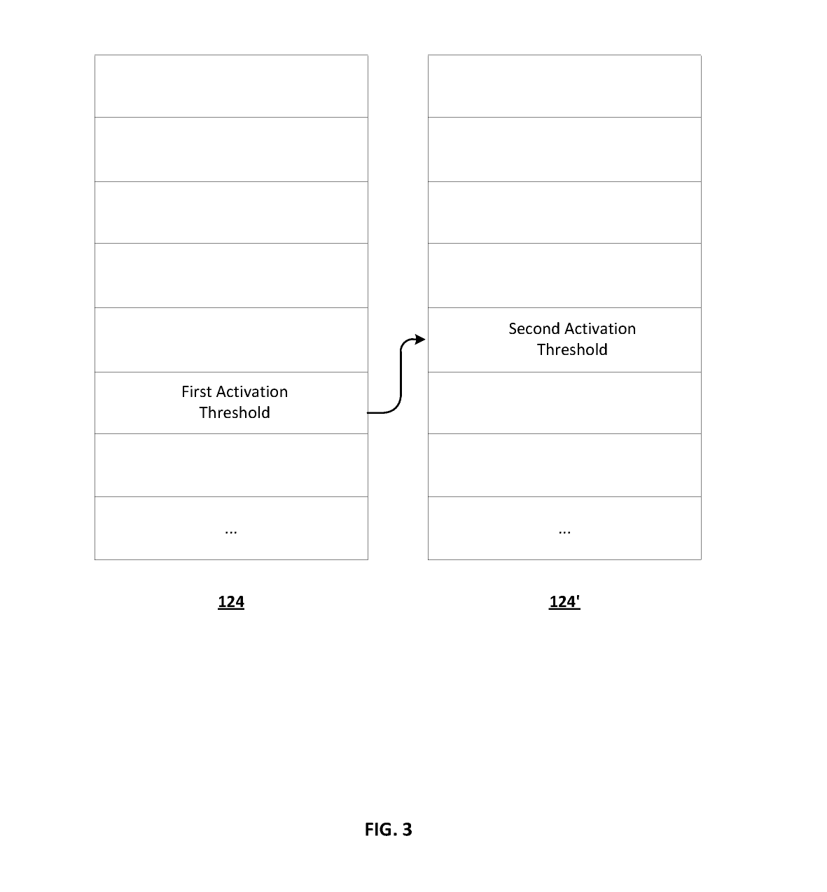

FIG. 3 illustrates a schematic diagram showing raising an activation threshold of request queue 124, according to embodiments of the disclosure. As shown in FIG. 3, when activation unit 110 determines area 200 contains more than one active queue, activation unit 110 can increase the activation threshold from a first activation threshold of queue 124 to a second activation threshold of queue 124′. It is contemplated that, the second activation threshold can be determined based on the first activation threshold, the activation number, and the number of active queues in the area. For example, the second activation threshold can be determined according to the equation as below:

$$SAT = FAT + \frac{N - T}{queue\_quit \_coef}$$

wherein SAT is the second activation threshold, FAT is the first activation threshold, N is the number of active queues in the area, T is the activation number, and queue_quit_coef is a predetermined coefficient.

Activation unit 110 can be further configured to determine whether the number of transportation service requests 122 is less than a deactivation threshold. When the determined number is less than the deactivation threshold (e.g., three requests), it indicates that the demand for priority service does not exceed the capacity of service vehicles significantly, and thus request queue 124 should be deactivated to release the computation capacity. It is contemplated that the deactivation threshold is less than the activation threshold.

After request queue 124 is activated, request queue 124 can remain active for a first reset period. When request queue 124 is activated, transportation service requests 122 can be lined up in request queue 124 for processing. It is possible that the number of transportation service requests 122 for request queue 124 can fall below the activation threshold immediately after request queue 124 is activated. By keeping request queue 124 active for the first reset period (e.g., 10 minutes), it can prevent request queue 124 from being deactivated too soon. In some embodiments, activation unit 110 can deactivate request queue 124 in response to the determined number being less than the deactivation threshold, after the request queue has been activated for the first reset period.

Similarly, in some embodiments, the deactivated request queue can remain deactivated for a second reset period before being reactivated. By keeping the request queue inactive for the second reset period (e.g., five minutes), it can prevent the request queue from being activated too soon.

Service providing unit 112 can be configured to provide transportation service according to respective positions of transportation service requests 122 in activated request queue 124. As discussed above, the transportation service request is associated with a plurality of features. The features can include at least one of: an origin, a destination, a vehicle model, a type, an estimated price, and the like. The type can include a car-pooling type and a non-car-pooling type. The positions of transportation service requests 122 in request queue 124 can be determined according to the above features.

As discussed above, when the number of requests 122 in request queue 124 is less than the deactivation threshold (e.g., five requests), request queue 124 can be deactivated. Therefore, it is possible that when request queue 124 is deactivated, some requests 122 can remain in deactivated request queue 124. Thus, service providing unit 112 can be configured to further provide the transportation service to requests 122 remaining in deactivated request queue 124. It is contemplated that, though the remaining transportation service requests in deactivated request queue 124 will continue to be fulfilled, no more requests can be accepted by request queue 124.

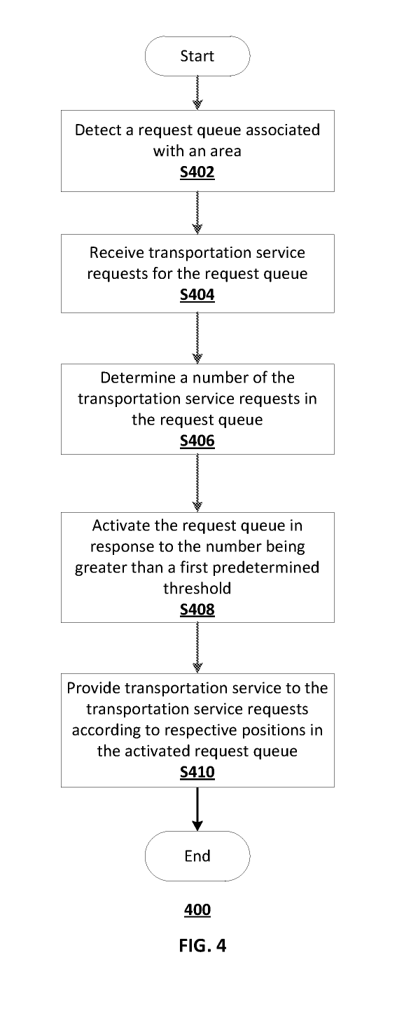

Another aspect of the disclosure is directed to a method for providing transportation service. FIG. 4 illustrates a flowchart of a method 400 for providing transportation service, according to embodiments of the disclosure. For example, method 400 may be implemented by system 100 including at least one processor, and method 400 may include steps S402-S410 as described below.

In step S402, system 100 can detect a request queue associated with an area. The request queue can be assigned to an area to serve priority service requests in the area. In the request queue, a priority of a request can be determined based on a collection of information associated with the requested transportation service, including, e.g., a request time, an origin, a destination, a length, an extra fee, a vehicle model, a type, an estimated price for the request or the like. Transportation service requests can be then queued based on the respective priorities. In some embodiments, the request queue can have a full capacity, e.g., 50 requests. When the request queue reaches the full capacity, the request queue cannot receive any further requests. In this case, system 100 can provide another request queue to the area for additional requests that are not accepted by the existing request queue.

In step S404, system 100 can receive transportation service requests, from remote terminal devices, to be placed in the request queue. The transportation service request can include a current location of the passenger, an origin and a destination of the requested transportation, a request time, or the like. The transportation service request can be associated with a plurality of features, such as a price feature, a type feature, an area feature, and the like. When multiple request queues are available in the area, system 100 can determine which of request queue the received transportation service request should assigned to, based on the request features.

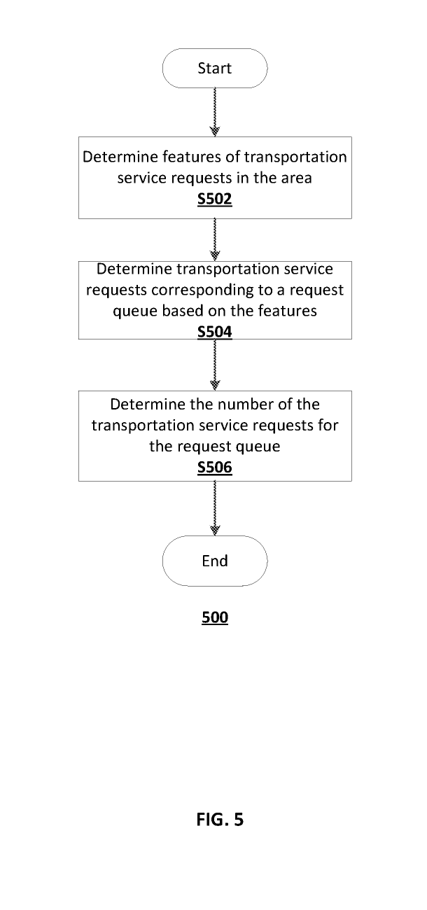

In step S406, system 100 can determine a number of transportation service requests for the request queue. It is contemplated that, when the request queue is detected, the request queue can be inactive. Therefore, system 100 can assign the service requests to the request queue, but cannot queue the service requests in the request queue yet. FIG. 5 illustrates a flowchart of a method 500 for determining a number of transportation service requests corresponding to a request queue, according to embodiments of the disclosure. Method 500 can be separate from or a part of method 400. Method 500 can include steps 502-506 as described below.

In step S502, system 100 can determine features of transportation service requests in the area. As discussed above, a type feature can be included in the transportation service request, and indicate a type of the transportation service, including a non-car-pooling type, a car-pooling type, and the like. The type features may determine which request queue the request should be assigned to. For example, a request with the non-car-pooling type should be assigned to a non-car-pooling request queue.

In step S504, system 100 can determine transportation service requests corresponding to a request queue based on the determined features. In some embodiments, system 100 can determine which transportation service requests are assigned to the request queue based on their type features.

Then in step S506, system 100 can determine the number of the transportation service requests assigned to the request queue.

With reference back to FIG. 4, in step S408, system 100 can activate the request queue in response to the determined number being greater than an activation threshold. When the determined number is greater than the activation threshold (e.g., five requests), it indicates that the demand for transportation service exceeds the capacity of service vehicles by a certain number, and a queue becomes necessary. In some embodiments, at least one queue may already be active in an area, and the activation threshold for activating additional queues can be determined based on the number of one of the existing active queues. To avoid having too many queues for a particular area in the same district, system 100 can be configured to increase the activation threshold in response as the number of existing active queues increases. In some embodiments, the activation threshold may be increased when the number of existing active queues exceed an activation number, for example, 1

System 100 can further determine whether the number of the transportation service requests is less than a deactivation threshold. When the determined number is less than the deactivation threshold (e.g., three requests), it indicates that the demand for priority service does not exceed the capacity of service vehicles significantly, and thus the request queue should be deactivated to release the computation capacity. It is contemplated that, the deactivation threshold is less than the activation threshold.

After the request queue is activated, the request queue can remain active for a first reset period. Therefore, system 100 can deactivate the request queue in response to the determined number being less than the deactivation threshold, after the request queue has been activated for the first reset period. Similarly, the deactivated request queue remains deactivated for a second reset period before being reactivated.

In step S410, system 100 can provide transportation service according to respective positions of the transportation service requests in the activated request queue. In some embodiments, system 100 can continue to provide transportation service to the requests remaining in a deactivated request queue. It is contemplated that, though the remaining transportation service requests in the deactivated request queue will continued to be fulfilled, no more requests can be accepted by the deactivated request queue.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for providing transportation service, comprising:
detecting, by at least one processor, a request queue associated with an area;
receiving transportation service requests, from remote terminal devices, to be placed in the request queue;
determining, by the at least one processor, a number of the transportation service requests for the request queue;
activating, by the at least one processor, the request queue in response to the determined number being greater than an activation threshold; and
providing transportation service according to respective positions of the transportation service requests in the activated request queue.

2. The method of claim 1, wherein the request queue remains active for a first reset period after being activated.

3. The method of claim 2, further comprising:
determining whether the number of the transportation service requests in the request queue is less than a deactivation threshold, wherein the deactivation threshold is less than the activation threshold; and
deactivating the request queue in response to the determined number being less than the deactivation threshold, after the request queue has been activated for the first reset period.

4. The method of claim 3, wherein the deactivated request queue is configured to receive no further transportation service request.

5. The method of claim 4, further comprising:
providing the transportation service to the transportation service requests remaining in the deactivated request queue.

6. The method of claim 1, wherein the area contains at least one active request queue and the method further comprises:
increasing the activation threshold in response to a number of the at least one active request queue being greater than an activation number.

7. The method of claim 1, wherein the transportation service request is associated with a plurality of features, and the plurality of features include at least one of:
an origin, a destination, a vehicle model, a type, and an estimated price.

8. The method of claim 7, wherein the type comprises a car-pooling type and a non-car-pooling type.

9. The method of claim 3, wherein the deactivated request queue remains deactivated for a second reset period before being reactivated.

10. The method of claim 8, wherein the positions of the transportation service requests in the request queue are determined according to the features.

11. A system for providing transportation service, comprising:
at least one processor configured to detect a request queue associated with an area;
a memory; and
a communication interface configured to receive transportation service requests, from remote terminal devices, to be placed in the request queue, wherein
the at least one processor is further configured to:
determine a number of the transportation service requests for the request queue;
activate the request queue in response to the determined number being greater than an activation threshold; and
provide transportation service according to respective positions of the transportation service requests in the activated request queue.

12. The system of claim 11, wherein the request queue remains active for a first reset period after being activated.

13. The system of claim 12, wherein the at least one processor is further configured to:
determine whether the number of the transportation service requests in the request queue is less than a deactivation threshold, wherein the deactivation threshold is less than the activation threshold; and
deactivate the request queue in response to the determined number being less than the deactivation threshold, after the request queue has been activated for the first reset period.

14. The system of claim 13, wherein the deactivated request queue is configured to receive no further transportation service request.

15. The system of claim 14, wherein the at least one processor is further configured to:
provide the transportation service to the transportation service requests remaining in the deactivated request queue.

16. The system of claim 11, wherein the area contains at least one active request queue and the at least one processor is further configured to:
increase the activation threshold in response to a number of the at least one active request queue being greater than an activation number.

17. The system of claim 11, wherein the transportation service request is associated with a plurality of features, and the plurality of features include:
an origin, a destination, a vehicle model, a type, and an estimated price.

18. The system of claim 13, wherein the deactivated request queue remains deactivated for a second reset period before being reactivated.

19. The system of claim 18, wherein the positions of the transportation service requests in the request queue are determined according to the features

20. A non-transitory computer-readable medium that stores a set of instructions, when executed by at least one processor of an electronic device, cause the electronic device to perform a method for providing transportation service, the method comprising:
detecting a request queue associated with an area;
receiving transportation service requests, from remote terminal devices, to be placed in the request queue;
determining a number of the transportation service requests for the request queue;
activating the request queue in response to the determined number being greater than an activation threshold; and
providing transportation service according to respective positions of the transportation service requests in the activated request queue.
